(19) United States
(12) Patent Application Publication
(10) Pub. No.: US 2013/0208009 A1
(43) Pub. Date: Aug. 15, 2013

(54) METHOD AND APPARATUS FOR OPTIMIZATION AND INCREMENTAL IMPROVEMENT OF A FUNDAMENTAL MATRIX

(71) Applicant: Anders Modén, Nassjo (SE)

(72) Inventor: Anders Modén, Nassjo (SE)

(73) Assignee: SAAB AB, Linkoeping (SE)

(21) Appl. No.: 13/876,822

(22) PCT Filed: Oct. 1, 2010
(86) PCT No.: PCT/SE2010/051058

§ 371 Date: Apr. 15, 2013

(51) Int. Cl. G06T 5/00

(52) U.S. Cl. CPC G06T 5/006
USPC 345/644

(57) ABSTRACT

A method and apparatus for generating and optimizing a fundamental matrix for a first 2D image and a second 2D image to obtain the relative geometrical information between said two 2D images for points in the two 2D images that correspond to a mutual 3D point. According to the method, the geometrical projection errors in the correspondence points are used to select correct and accurate inliers. This method and apparatus provides a more accurate and precise fundamental matrix than conventional methods.

### TECHNICAL FIELD

The present invention relates to the field of computer vision and epipolar geometry, the intrinsic geometry between two views, or images, encapsulated by the fundamental matrix.

The invention relates to a method generating and optimizing a fundamental matrix for a first 2D image and a second 2D image to obtain the relative geometrical information between the two 2D images for points in the two 2D images that correspond to a mutual 3D point.

The invention further relates in general to generating a fundamental matrix from two 2D images and in particular to an apparatus for providing an optimized fundamental matrix for a first 2D image and a second 2D image to obtain the relative geometrical information between said two 2D images for points in the two 2D images that correspond to a mutual 3D point, wherein said apparatus comprising a memory and a processor.

### BACKGROUND ART

Today, there exist various examples of methods for estimating a fundamental matrix. Usually, these present solutions are restricted in using different parameterizations of the fundamental matrix in combination with methods such as LevenBerg-Marquard in order to estimate fundamental matrix. These methods are using all points when estimating the fundamental matrix without considering if these points meet the criteria of being an inlier, “good point”, or being an outlier, “bad point”. These present solutions are not restricted to inliers, and all outliers have not been removed. Thus, the estimation of the fundamental matrix is based on correspondences that are spoilt by noise and outliers. This creates a systematical error in the estimation of the fundamental matrix.

US2004/0213452 describes a type of known method for estimating a fundamental matrix. However this type of method is restricted in using Least-Median-Squares (LMedS) which calculates the median of distances between points and epipolar lines for the fundamental matrix, and lack the ability to minimize the number of outliers to refine the accuracy of the fundamental matrix.

These present solutions provide uncertain estimations of the fundamental matrix, not necessarily minimizing the number of outliers used to refine the accuracy and optimize the fundamental matrix.

There is thus a need for an improved method and apparatus for estimating and providing a precise and accurate fundamental matrix between a first image and a second image removing the above mentioned disadvantages.

### SUMMARY

The present invention is defined by the appended independent claims.

Various examples of the invention are set forth by the appended dependent claims as well as by the following description and the accompanying drawings.

With the above description in mind, then, an aspect of the present invention is to provide a solution of providing an accurate and precise fundamental matrix which seeks to mitigate, alleviate, or eliminate one or more of the above-identified deficiencies in the art and disadvantages singly or in any combination.

The object of the present invention is to provide an inventive method and apparatus, refining the accuracy of the fundamental matrix for a first 2D image and a second 2D image where previously mentioned problems are partly avoided. The object is achieved by the features of claim 1 wherein, a method for generating and optimizing a fundamental matrix for a first 2D image and a second 2D image to obtain the relative geometrical information between said two 2D images for points in the two 2D images that correspond to a mutual 3D point, characterized in that said method comprises the steps of:
I. selecting a number of at least 8 start correspondence points;
II. calculating an initial fundamental matrix using eight-point algorithm and single value decomposition (SVD) with normalized frobenius norm;
III. calculating the sum of the geometrical projection errors of said start correspondence points from said initial fundamental matrix;
IV. selecting a new correspondence point, using random sample consensus (RANSAC), recalculating the fundamental matrix with said new correspondence point, recalculating the sum of the geometrical projection errors from the recalculated fundamental matrix, adding said new correspondence point if the recalculated sum of the geometrical projection errors is less than before;
V. iterating step I-IV using new start correspondence points, until a pre-determined iteration value is obtained, storing the sum of the geometrical projection errors of said new start correspondence points and the corresponding new fundamental matrix if the new fundamental matrix has less geometrical projection errors than earlier iterations;
VI. calculating the geometrical projection error in all correspondence points of the total amount of correspondence points, selecting the correspondence points which have a lesser geometrical projection error than a threshold value; and
VII. iterating step I-VI using said selected correspondence points, iterating and repeating steps I-VI recursively and successively with lower threshold values until the number of correspondence points is stable and no correspondence points are removed and thereby obtaining the fundamental matrix.

Said object is further achieved by the features of claim 6, wherein an apparatus for generating and providing an optimized fundamental matrix for a first 2D image and a second 2D image to obtain the relative geometrical information between said 2D two images for points in the two 2D images that correspond to a mutual 3D points, wherein said apparatus comprises:
a memory; and
a processor,
   characterized in that said memory is encoded with instructions that, when executed, causes the processor to receive input from at least two 2D images wherein the apparatus is capable of:
   I. selecting a number of at least 8 start correspondence points;
II. calculating an initial fundamental matrix using eight-point algorithm and single value decomposition (SVD) with normalized frobenius norm;
   III. calculating the sum of the geometrical projection errors of said start correspondence points from said initial fundamental matrix;
   IV. selecting a new correspondence point, using random sample consensus (RANSAC), recalculating the fundamental matrix with said new correspondence point, recalculating the sum of the geometrical projection errors from the recalculated fundamental matrix, adding said new correspondence point if the recalculated sum of the geometrical projection errors is less than before;
   V. iterating step I-IV using new start correspondence points, until a pre-determined iteration value is obtained, storing the sum of the geometrical projection errors of said new start correspondence points and the corresponding new fundamental matrix if the new fundamental matrix has less geometrical projection errors than earlier iterations;
   VI. calculating the geometrical projection error in all correspondence points of the total amount of correspondence points, selecting the correspondence points which have a lesser geometrical projection error than a threshold value; and
   VII. iterating step I-VI using said selected correspondence points, iterating and repeating steps I-VI recursively and successively with lower threshold values until the number of correspondence points is stable and no correspondence points are removed and thereby obtaining the fundamental matrix.

According to a further advantageous aspect of the invention, the sum of the geometrical projection errors of said start correspondence points, which is calculated from said initial fundamental matrix in step III, is obtained by:
a. calculating an estimate of each 3D point's location for said fundamental matrix and for each pair of correspondence points, resulting in an estimated 3D coordinate for each pair of correspondence points;
b. calculating the geometrical projection error of said projected 3D coordinate, using the homography of said fundamental matrix;
c. summarizing the geometrical projection errors and divide the sum with a number representing the amount of correspondence points.

According to a further advantageous aspect of the invention, the relation of the correspondence point x and x′ in the respective two 2D images, and the fundamental matrix F is as Equation 1:

x′^{T}Fx=0 [Equation 1].

According to a further advantageous aspect of the invention, the number of start correspondence points to be selected for calculating an initial fundamental matrix in steps I and II is preferably in the range of 12 to 15.

According to a further advantageous aspect of the invention, the pre-determined iteration value N in step V is a pre-determined number of iterations determined by the following equation:

N=n² [Equation 2]

where, n is the number of the sample points, i.e. corresponding points.

According to a further advantageous aspect of the invention, the pre-determined iteration value N in step V may be determined and constrained by a time value.

According to a further advantageous aspect of the invention, the threshold value in step VI is less than one tenth of the pixel dimension size.

Any of the advantageous features of the present invention above may be combined in any suitable way.

A number of advantages are provided by means of the present invention, for example:
a method and apparatus with a stabile convergence which may handle a numerous amount of points where all combinations cannot be calculated, is obtained;
a solution is obtained which results in that outliers are removed, which normally would not have been removed;
correspondence analysis where the number of outliers are minimized is obtained;
by using different threshold values an optimized method and apparatus for obtaining the fundamental matrix is obtained;
a more robust, accurate and precise estimation of the fundamental matrix is obtained, which without further processing can be used in other methods and algorithms.

### BRIEF DESCRIPTION OF THE DRAWINGS

The present invention will now be described in detail with reference to the figures, wherein:

FIG. 1 schematically shows a pictorial representation of the epipolar geometry.

FIG. 2 schematically shows a pictorial representation of the epipolar geometry, rotation and translation.

FIG. 3 schematically shows a pictorial representation of three translation axes and the rotation around them.

FIG. 4 schematically shows a pictorial representation of a flow chart for the process of determining the fundamental matrix according to the present invention.

FIG. 5 schematically shows a pictorial representation of the geometrical projection error.

### DETAILED DESCRIPTION

Examples of the present invention relate, in general, to the field of epipolar geometry, in particularly, to generate, refine and optimize a fundamental matrix for a first 2D view and a second 2D image to obtain the relative geometrical information between the two 2D images for points in the two 2D images that correspond to a mutual 3D point. The images, or views, may constitute any type of picture or any type of image from a camera or video sequence from a video camera.

Examples of the present invention will be described more fully hereinafter with reference to the accompanying drawings, in which examples of the invention are shown. This invention may, however, be embodied in many different forms and should not be construed as limited to the examples set forth herein. Rather, these examples are provided so that this disclosure will be thorough and complete, and will fully convey the scope of the invention to those skilled in the art. Like reference signs refer to like elements throughout.

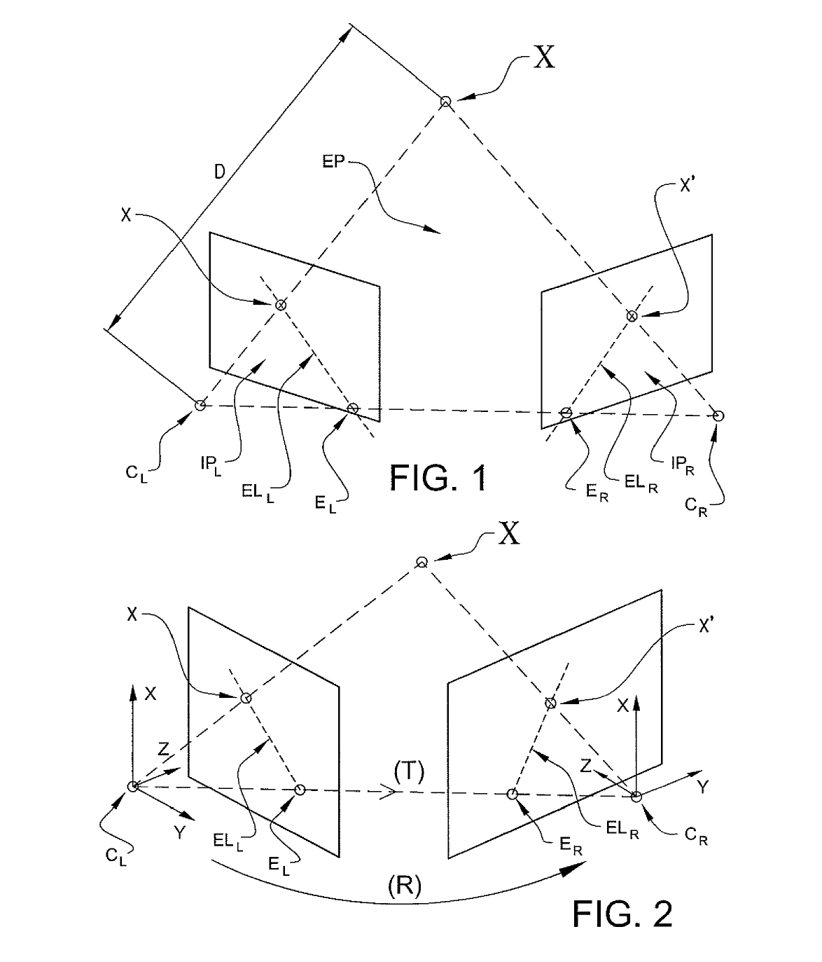

All the FIGS. 1 to 5 are schematically illustrated.

Epipolar Geometry

FIG. 1 shows an example of two cameras taking a picture of the same scene from different points of views. The epipolar geometry then describes the relation between the two resulting views. The epipolar geometry is the intrinsic projective geometry between two views, or images. It is independent of scene structure, and only depends on a camera's internal parameters and relative pose. Epipolar geometry is a fundamental constraint used when images of a static scene are to be registered. When two cameras view a 3D scene from two different positions, there are a number of geometric relations between the 3D points and their projections onto the 2D images that lead to constraints between the image points. This generalized constraint, called epipolar constraint, can be used to estimate relative motion between two images. The epipolar constraint can be written as

x′^{T}Fx=0 [Equation 1]

where, x and x′ are the homogeneous coordinates of two corresponding points in the two images, and F is the fundamental matrix. The homogeneous coordinates x and x′ are vectors. The homogeneous coordinate x′^{T} in equation 1 is the transpose of the homogeneous coordinate x′.

Epipolar geometry is the geometry of computer stereo vision. Computer stereo vision is the extraction of 3D information from digital images, such as obtained for example by a camera or a video camera. The camera may be a CCD camera and the images may constitute a video sequence. By comparing information about a scene from several camera perspectives, 3D information may be extracted by examination of the relative perspectives. As previously mentioned, when two cameras view a 3D scene from two different positions, there are a number of geometric relations between the 3D points and their projections onto the 2D images that lead to constraints between the image points. These relations are derived based on the assumption that the camera or cameras can be approximated by the pinhole camera model. The pinhole camera model describes the mathematical and geometric relationship between a 3D point and its 2D corresponding projection onto the image plane

In the epipolar geometry, the relation between two images provided from different cameras may be explained with a correspondence of a point to a line, rather than a correspondence of a point to a point. It could also be the same camera taking images from different views. FIG. 1 shows the epipolar geometry, that for a point in one image, there is a corresponding point in the other image where the two points are the projections of the same physical point in 3D space, the original 3D space point. These two points are normally called correspondence points or corresponding points. The original 3D space point is a point positioned on an item which is imaged by the camera. A plane made by a point in 3D space X, and a first camera C_{L}, left camera, and a second camera C_{R}, right camera, is called an epipolar plane EP. The intersection line of the epipolar plane EP and the image plane are called an epipolar line. FIG. 1 shows, a left image plane IP_{L} and a left epipolar line EL_{L} and also a right image plane IP_{R} and a right epipolar line EL_{R}. The intersection point made by the image plane and the line linking the two cameras C_{L} and C_{R} is called epipole. Referring to FIG. 1, the points E_{L} and E_{R} are the epipoles. All epipolar lines intersect at the epipole regardless of where the 3D space point X is located. An epipolar plane EP intersects the left and right image planes IP_{R}, IP_{L} in the left and right epipolar lines EL_{L}, EL_{R} and defines the correspondence between the lines. FIG. 1 show, a distance D relating to the distance from the first camera through the image point.

For a point in one image, the corresponding point in the second image is constrained to lie on the epipolar line. This means that for each point which is observed in one image the same point must be observed in the other image on a known epipolar line. This provides the epipolar constraint relation which corresponding image points must satisfy and it means that it is possible to test if two points really correspond to the same 3D point in space. Epipolar constraints can also be described by the essential matrix E or the fundamental matrix F. The essential matrix is a 3×3-matrix and has rank 2.

The essential matrix has 5 degrees of freedom, 3 for rotation and 2 for translation. Both the fundamental matrix and the essential matrix can be used for establishing constraints between matching image points. However, the essential matrix can only be used in relation to calibrated cameras since the intrinsic parameters, i.e. the internal camera parameters, must be known when using the essential matrix. The essential matrix only encodes information of the extrinsic parameters i.e. the external camera parameters which are rotation R and direction of translation T from one camera to the other. The extrinsic parameters determine the cameras orientation towards the outside world. Rotation and translation are the external parameters which signify the coordinate system transformations from 3D world coordinates to 3D camera coordinates. The rotation and translation parameters define the position of the camera center and the camera's heading in world coordinates. If the cameras are calibrated, the essential matrix can be used for determining both the relative position and orientation between the cameras and the 3D position of corresponding image points. The fundamental matrix encodes information of both the extrinsic parameters and the intrinsic parameters. The fundamental matrix encapsulates the epipolar geometry and will be further described below.

Fundamental Matrix

The fundamental matrix contains all available information of the camera geometry and it can be computed from a set of correspondence points. The fundamental matrix defines the geometry of the correspondences between two views, or images, in a compact way, encoding intrinsic camera geometry as well as extrinsic relative motion between two cameras. The fundamental matrix is a homogeneous 3×3-matrix, entity of 9 parameters, and is constrained to have a rank 2. The fundamental matrix has seven degrees of freedom. If a point in 3-D-space X is imaged as x in the first image (left image in FIG. 1), and as x′ in the second image (right image in FIG. 1), then the image points satisfy the relation of equation 1.

F is the fundamental matrix and can be estimated linearly from equation 1, given a minimum of 8 correspondence points between two images. 8 correspondence points results in 8 points in the first image and 8 points in the second image, giving a total number of 16 points. The fundamental matrix is the algebraic representation of epipolar geometry, independent of scene structure and can be computed from correspondences of imaged scene points alone, without requiring knowledge of the cameras' internal parameters or relative pose.

Estimating the fundamental matrix is crucial for structure and motion problems where information, such as when the location of the camera and 3D scene is retrieved from several images. Estimating the fundamental matrix is vital for image based navigation and since the fundamental matrix contains the internal camera parameters and the rigid transformation between two cameras, it is also used in a number of different areas such as video tracking, stereo matching, image rectification and restoration, object recognition, outlier detection and motion estimation.

A set of correspondence points between two images will always contain noise and outliers. Outliers refer to anomalies, or errors, in a given data set. It is an outlying observation that appears to deviate markedly from an optimal or accurate solution. The outliers may come from extreme values of noise or from erroneous measurements or incorrect hypotheses about the interpretation of data. Outliers may also be defined as data that do not fit the model. In order to estimate an accurate solution, it is preferable to find a solution without deviations and anomalies in the data set, i.e. outliers. Thus, based on a predetermined criterion, outliers are false feature correspondences.

Correct feature correspondences are called inliers and they result in an accurate solution. Inliers may also be defined as data whose distribution can be explained by some set of model parameters. The fundamental matrix can be estimated from the information of the correspondence points and in order to achieve an accurate and precise fundamental matrix, it is important to minimize the effect and influence of outliers. The fundamental matrix is sensitive to anomalies, or errors, in the corresponding points. Thus, it is essential to select inliers for a precise and accurate fundamental matrix.

The methods and algorithms used in the proposed method and apparatus for estimating the fundamental matrix are the linear method, the iterative method and the robust method.

For the proposed method and apparatus which will be further disclosed, a linear method is used in order to first estimate an initial fundamental matrix and eventually an accurate fundamental matrix. The eight-point algorithm is used when estimating an initial fundamental matrix. The eight-point algorithm is fast and easily implemented. The eight-point algorithm is used in the present invention whether only eight corresponding points or more than eight corresponding points are used. When using eight or more than eight correspondence points, eight-point algorithm together with single value decomposition (SVD) with Frobenius norm is used in the proposed method in order to calculate an initial fundamental matrix. The SVD minimizes the

Frobenius norm so that the rank of the resulting matrix is 2. SVD is an important factorization of a rectangular real or complex matrix, with many applications in, for example, signal processing and statistics. Applications which employ the SVD include computing the pseudoinverse, least squares fitting of data, matrix approximation, and determining the rank, range and null space of a matrix. Frobenius norm is a matrix norm which is a natural extension of the notion of a vector norm to matrices. The proposed method and apparatus provide a solution that combines the linear method, the iterative method and the robust method rejecting models containing outliers.

The iterative method used in the proposed method and apparatus for obtaining an accurate fundamental matrix are based on optimizing and finding a lesser geometrical projection error between the correspondence points than earlier iterations or than a threshold value. The number of iterations may vary. Criteria's for the number of iterations made in the present invention may be a time constraint and/or a threshold value and/or a pre-determined value representing the amount of iterations.

Further, random sample consensus (RANSAC) is used for obtaining an accurate fundamental matrix. RANSAC is an iterative method used to estimate parameters of a mathematical model from a set of observed data which contains outliers. RANSAC has the ability to do robust estimation of the model parameters, i.e., it can estimate the parameters with a high degree of accuracy even when significant amount of outliers are present in the data set. RANSAC produces a reasonable result with a certain probability. This probability is increasing as more iterations are allowed. RANSAC also assumes that, given a set of inliers, there exists a procedure which can estimate the parameters of a model that optimally explains or fits this data.

The accurate fundamental matrix obtained by the proposed method and apparatus may then be used for correspondence of all feature points between the two images.

External Camera Parameters (Rotation R and Translation T)

When the fundamental matrix F and the internal camera parameters are known we can solve the external camera parameters (rotation and translation) and determine 3D structure of a scene. The external parameters determine the cameras orientation towards the outside world. R is the 3×3 rotation matrix and T is the 1×3 translation vector. Referring to FIG. 2, if the left camera C_{L} represents a global frame of reference in which objects exist (world frame), then the other camera C_{R} is positioned and orientated by a

Euclidean transformation (rotation R, translation T). FIG. 2, schematically shows a pictorial representation of the coordinate x in the first image taken by camera C_{L} and the coordinate x′ in the second image taken by camera C_{R} of a 3d space point. The two coordinates x and x′ in the first and the second image in FIG. 2 may be taken by two different cameras or with the same camera.

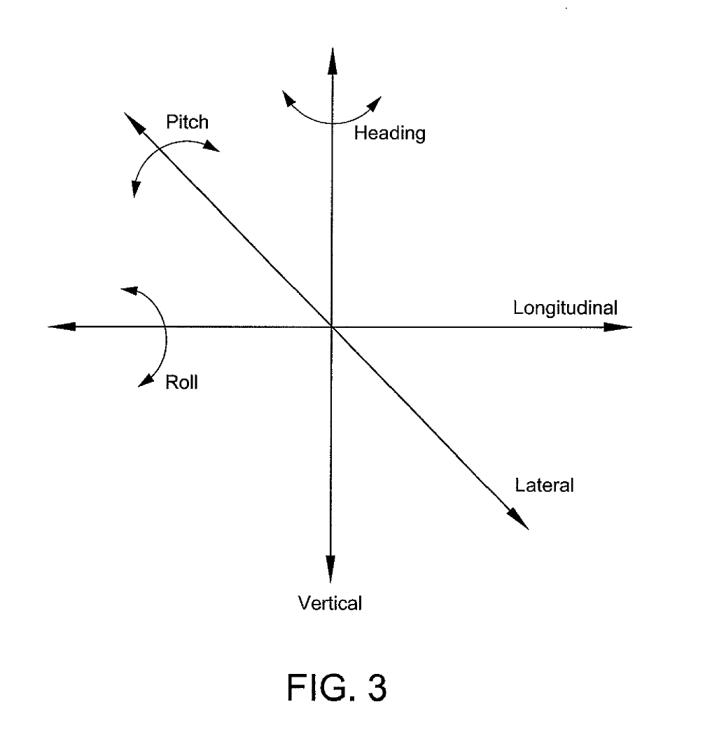

The essential matrix can be determined from the fundamental matrix and the camera calibration 3×3 matrix K. K is also called projection matrix and represents the intrinsic parameters of the camera. In order to determine rotation and translation from one camera to the other camera, or one image to the other, the rotation and translation can be determined by factoring the essential matrix with single value decomposition (SVD) to 4 different possible combinations of translations and rotations. One of these combinations is correct. By looking at their geometric interpretation we may determine which of these combinations are correct. FIG. 3 shows how a camera may be rotated around three different axes which are the longitudinal axis, the lateral axis and the vertical axis. The rotation around these axes is called roll, heading (yaw) and pitch. The rotation and translation components are extracted from the essential matrix and then the 3D point locations can be determined.

One Embodiment of the Present Invention

A method and apparatus are provided in this detailed disclosure for obtaining an accurate and precise fundamental matrix. In the embodiment of the present invention, the method is computer-implemented. The computer-implemented method can be realized at least in part as one or more programs running on a computer as a program executed from a computer-readable medium such as a memory by a processor of a computer. The programs are desirably storable on a machine-readable medium such as a floppy disk or a CD-ROM, for distribution and installation and execution on other computers. Further, the computer-implemented method can be realized at least in part in hardware by using a programmable array in a processor/FPGA technique or other hardware.

In order to minimize the number of outliers and to provide an accurate fundamental matrix, the present method and apparatus uses the geometrical projection errors of the correspondence points to choose the fundamental matrix with minimized outliers and the least error. The method and apparatus for generating an accurate fundamental matrix between a first and a second image of a scene contain correspondence analysis and outlier elimination.

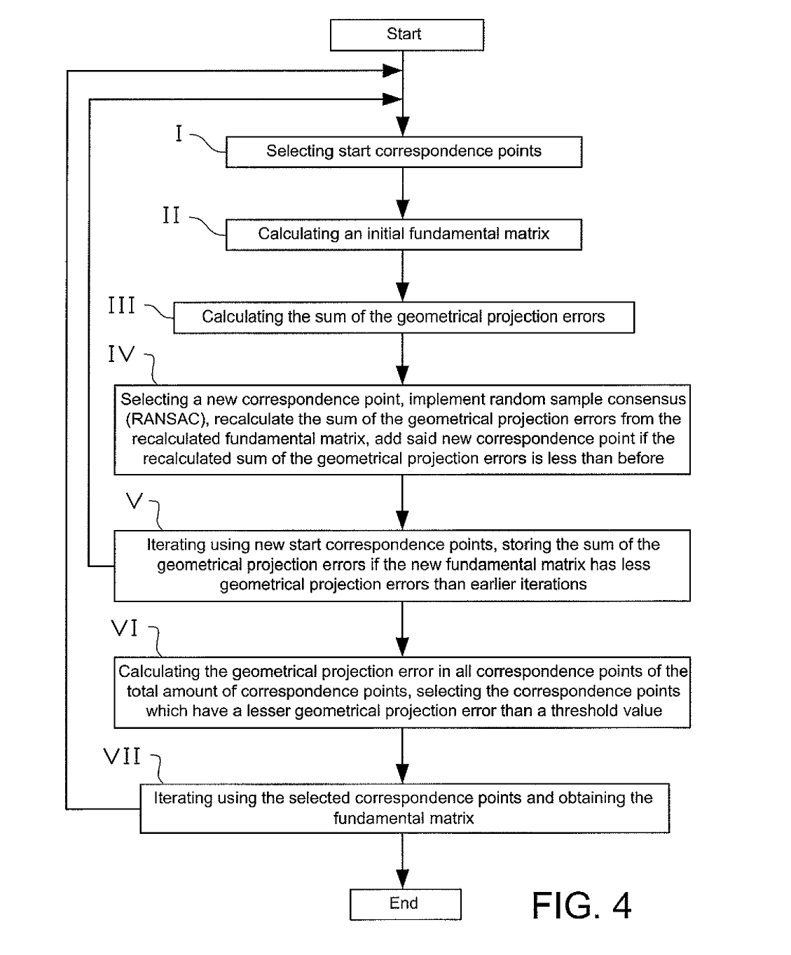

FIG. 4 schematically shows a flowchart of a specific method according to the present invention. Hereinafter, referring to FIG. 4, the method of the present invention is explained in detail.

First, a number of at least 8 start correspondence points are selected (step I). The pairs of at least 8 corresponding start points may be selected in a normal distribution random manner. The pairs of at least 8 corresponding start points may be randomly selected. Then, an initial fundamental matrix is calculated from the eight-point method and single value decomposition (SVD) with normalized frobenius norm (step II). The number of start correspondence points which is selected in order to obtain an initial fundamental matrix in steps (I) and (II) is preferably in the range of 12 to 15. Selecting start correspondence points in the range of 12 to 15 provides a robust and statistically good start for implementing the present invention.

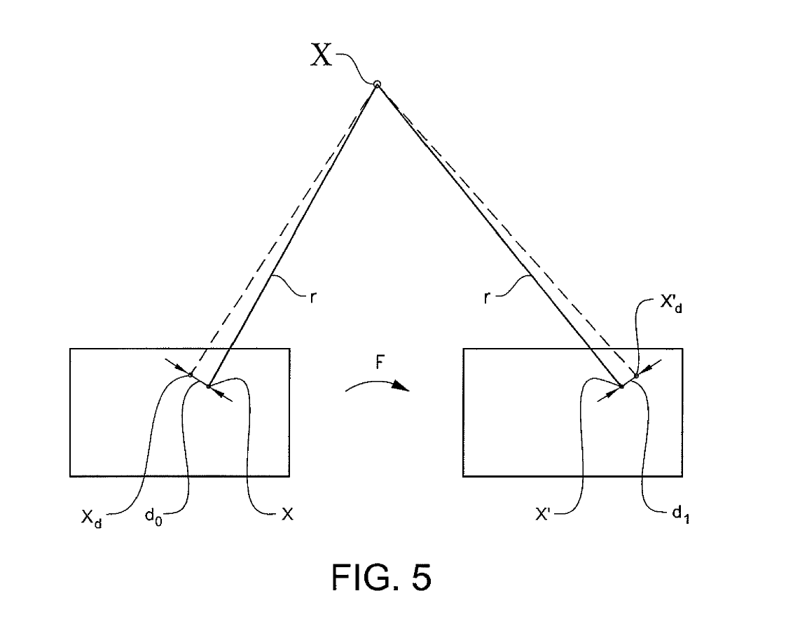

Then, the sum of the geometrical projection errors of said start correspondence points from said initial fundamental matrix is calculated (step III). FIG. 5 shows a point X in 3D space imaged as x in a first image and as x′ in a second image. In order to receive the geometrical projection error, the point x in the first image is projected to the second image as x′d and the point x′ in the second image is projected to the first image as x_{d}. The projection is done using the fundamental matrix in combination with SVD. FIG. 5 further show the error distance d₀ being the distance between x and x_{d} and the error distance d₁ being the distance between x′ and x′d. The error distances d₀ and d₁ result in the geometrical projection error d of the corresponding points. The error distances d₀ and d₁ is the orthogonal distance between x and x_{d}; and x′ and x′_{d} respectively. The geometrical projection error d is determined by the following equation:

d=\sqrt{d₀²+d₁²} [Equation 3]

The sum of the geometrical projection errors of said start correspondence points is calculated by first calculating an estimate of each 3D point's location for said fundamental matrix F and for each pair of correspondence points which results in an estimated 3D coordinate for each pair of correspondence points. This may be done by using SVD or a cross product resulting in a calculated coordinate in 3D for each pair of correspondence points where each points respective rays r, shown in FIG. 5, intersect with each other. Then, calculate the geometrical projection error of said projected 3D coordinate, using the homography of said fundamental matrix. Finally, summarize the geometrical projection errors and divide the total sum with a number which represents the amount of correspondence points. The sum of the geometrical projection errors from said initial fundamental matrix is now obtained. The projected geometrical error is later used in the random sample consensus (RANSAC) to determine an error of each correspondence point. By using the estimated projected geometrical error, the errors are made clear and protrude like spikes in a distance error graph between a first and a second image whereas outliers are easily detected. This enables the present invention to involve greater quantifiable boundaries between inliers and outliers and the number of outliers can be minimized.

Then, select a new correspondence point, using random sample consensus (RANSAC), recalculate the fundamental matrix with said new correspondence point, recalculate the sum of the geometrical projection errors from the recalculated fundamental matrix and add said new correspondence point if the recalculated sum of the geometrical projection errors is less than before (step IV).

Then, iterate step I-IV using new start correspondence points, until a pre-determined iteration value N is obtained, store the sum of the geometrical projection errors of said new start correspondence points and the corresponding new fundamental matrix if the new fundamental matrix has less geometrical projection errors than earlier iterations (step V). New start correspondence points may be selected in a normal distribution random manner. The new start correspondence points may be randomly selected. Criteria's for the number of iterations made in step V may be a time constraint and/or a pre-determined amount of iterations. The number of iterations made in step V depends on the pre-determined iteration value N.

The number of iterations, i.e. the pre-determined iteration value N, may vary depending on a time constraint or a selected and pre-determined number of iterations. The number of iterations which shall be done in the present invention may be set to a pre-determined amount of iterations, such as for example 10 iterations or 100 iterations or 1000 iterations. The number of iterations may be set to a pre-determined number based on the number of sample points n, i.e. correspondence points. The pre-determined iteration value N in step V may be a pre-determined number of iterations determined by the following equation:

N=n² [Equation 2]

where n is the number of the sample points, i.e. corresponding points. Further, the pre-determined iteration value N in step V may be a pre-determined number of iterations determined by the following equation:

N=nlogn [Equation 4]

where n is the number of the sample points, i.e. corresponding points. Further, a time constraint may be used to regulate the number of iterations performed in step V. The time constraint may be set to any appropriate time, such as 5 seconds or 10 seconds. The iteration in step V is completed either when a pre-determined number N of iterations are obtained or when a pre-determined iteration time is obtained. The pre-determined number of iterations or the pre-determined iteration time corresponds to the pre-determined iteration value in step V. The present invention may store a great number of points, for example 1000 or several 1000 points, which results in less error per number of included sample, i.e. correspondence points. This since the sum of the errors is divided with a number which represents the amount of correspondence points. Thus, the more points stored the less error per number of included samples.

Then, calculate the geometrical projection error in all correspondence points of the total amount of correspondence points and select the correspondence points which have a lesser geometrical projection error than a threshold value (step VI). The threshold value may be used to regulate the number of iterations in step VII and depends on the accuracy of the corresponding measurements of the corresponding points. The threshold value is an accuracy constraint used for the calculated geometrical projection error and may be set to any appropriate value. The threshold value is preferably a value less than a tenth of a pixel dimension size. The pixel dimension size is the height and the width of one pixel in an image. The pixel dimension size is the horizontal and vertical measurements of one pixel in each dimension in an image expressed in pixels. Further, the threshold value may be determined by the following equation:

TV=2/h [Equation 5]

where, TV is the threshold value and h is the height of one pixel in the image. Further, the threshold value may be determined by the following equation:

TV=2/w [Equation 6]

where, TV is the threshold value and w is the width of one pixel in the image.

Finally, iterate step I-VI using said selected correspondence points which have a lesser geometrical projection error than a threshold value and obtain the fundamental matrix. Steps I-VI are iterated and repeated recursively and successively with lower threshold values until the number of correspondence points is stable and no correspondence points are removed and thereby obtaining the fundamental matrix (step VII). By repeating the steps I-VI the method starts from the first step I, with a lesser amount of points which are statistically better. Most of the outliers are removed and also the points which have a lesser geometrical projection error and that does not match are removed. By recursively and successively repeating the method with different threshold values an accurate and precise fundamental matrix is obtained until for example no points are removed. Thus, the method can be optimized by controlling different parameters such as a threshold value or a significance value of points. Since the present invention does not start with the first best solution in the beginning of the method it allows a great number of points to be included in providing a robust method with a stable convergence for obtaining an accurate fundamental matrix.

The views encapsulated by the fundamental matrix may be images from a camera, or images or a video sequence from a video camera.

The invention is not limited to the example described above, but may be modified without departing from the scope of the claims below.

The terminology used herein is for the purpose of describing particular examples only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

The foregoing has described the principles, preferred examples and modes of operation of the present invention. However, the invention should be regarded as illustrative rather than restrictive, and not as being limited to the particular examples discussed above. The different features of the various examples of the invention can be combined in other combinations than those explicitly described. It should therefore be appreciated that variations may be made in those examples by those skilled in the art without departing from the scope of the present invention as defined by the following claims.

1-14. (canceled)

15. A method for generating and optimizing a fundamental matrix for a first 2D image and a second 2D image to obtain the relative geometrical information between said two 2D images for points in the two 2D images that correspond to a mutual 3D point, said method comprising the steps of:
I. selecting a number of at least 8 start correspondence points;
II. calculating an initial fundamental matrix using eight-point algorithm and single value decomposition (SVD) with normalized frobenius norm;
III. calculating the sum of the geometrical projection errors of said start correspondence points from said initial fundamental matrix;
IV. selecting a new correspondence point, using random sample consensus (RANSAC), recalculating the fundamental matrix with said new correspondence point, recalculating the sum of the geometrical projection errors from the recalculated fundamental matrix, adding said new correspondence point if the recalculated sum of the geometrical projection errors is less than before;
V. iterating step I-IV, until a pre-determined iteration value is obtained, using new start correspondence points, storing the sum of the geometrical projection errors of said new start correspondence points and the corresponding new fundamental matrix if the new fundamental matrix has less geometrical projection errors than earlier iterations;
VI. calculating the geometrical projection error in all correspondence points of the total amount of correspondence points, selecting the correspondence points which have a lesser geometrical projection error than a threshold value; and
VII. iterating step I-VI using said selected correspondence points, iterating and repeating steps I-VI recursively and successively with lower threshold values until the number of correspondence points is stable and no correspondence points are removed and thereby obtaining the fundamental matrix.

16. The method according to claim 15, wherein the sum of the geometrical projection errors of said start correspondence points, which is calculated from said initial fundamental matrix in step III, is obtained by:
a. calculating an estimate of each 3D point's location for said fundamental matrix and for each pair of correspondence points, resulting in an estimated 3D coordinate for each pair of correspondence points;
b. calculating the geometrical projection error of said projected 3D coordinate, using the homography of said fundamental matrix; and
c. summarizing the geometrical projection errors and divide the sum with a number representing the amount of correspondence points.

17. The method according to claim 15, wherein the relation of the correspondence point x and x′ in the respective two 2D images, and the fundamental matrix F is as Equation 1:
x′^{T}Fx=0 [Equation 1]

18. The method according to claim 15, wherein the number of start correspondence points to be selected for calculating an initial fundamental matrix in steps I and II is in the range of 12 to 15.

19. The method according to claim 15, wherein the pre-determined iteration value N in step V is a pre-determined number of iterations determined by the following equation:
N=n² [Equation 2]
where,
n is the number of the sample points, i.e. correspondence points.

20. The method according to claim 15, wherein the pre-determined iteration value N in step V is determined and constrained by a time value.

21. The method according to claim 15, wherein the threshold value in step VI is less than one tenth of the pixel distance.

22. An apparatus for generating and providing an optimized fundamental matrix for a first 2D image and a second 2D image to obtain the relative geometrical information between said 2D two images for points in the two 2D images that correspond to a mutual 3D points, said apparatus comprising:
a processor; and
a memory encoded with instructions that, when executed cause the processor to receive input from at least two 2D images, said processor being further configured for:
I. selecting a number of at least 8 start correspondence points;
II. calculating an initial fundamental matrix using eight-point algorithm and single value decomposition (SVD) with normalized frobenius norm;
III. calculating the sum of the geometrical projection errors of said start correspondence points from said initial fundamental matrix;
IV. selecting a new correspondence point, using random sample consensus (RANSAC), recalculating the fundamental matrix with said new correspondence point, recalculating the sum of the geometrical projection errors from the recalculated fundamental matrix, adding said new correspondence point if the recalculated sum of the geometrical projection errors is less than before;
V. iterating step I-IV using new start correspondence points, until a pre-determined iteration value is obtained, storing the sum of the geometrical projection errors of said new start correspondence points and the corresponding new fundamental matrix if the new fundamental matrix has less geometrical projection errors than earlier iterations;
VI. calculating the geometrical projection error in all correspondence points of the total amount of correspondence points, selecting the correspondence points which have a lesser geometrical projection error than a threshold value; and
VII. iterating step I-VI using said selected correspondence points, iterating and repeating steps I-VI recursively and successively with lower threshold values until the number of correspondence points is stable and no correspondence points are removed and thereby obtaining the fundamental matrix.

23. An apparatus according to claim 22, wherein the sum of the geometrical projection errors of said start correspondence points, which is calculated from said initial fundamental matrix in step III, is obtained by:
a. calculating an estimate of each 3D point's location for said fundamental matrix and for each pair of correspondence points, resulting in an estimated 3D coordinate for each pair of correspondence points;
b. calculating the geometrical projection error of said projected 3D coordinate, using the homography of said fundamental matrix; and
c. summarizing the geometrical projection errors and divide the sum with a number representing the amount of correspondence points.

24. An apparatus according to claim 22, wherein the number of start correspondence points to be selected for calculating an initial fundamental matrix in steps I and II is in the range of 12 to 15.

25. An apparatus according to claim 22, wherein the pre-determined iteration value N in step V is a pre-determined number of iterations determined by the following equation:
N=n² [Equation 2]
where,
n is the number of the sample points, i.e. correspondence points.

26. An apparatus according to claim 22, wherein the pre-determined iteration value N in step V is determined and constrained by a time value.

27. An apparatus according to claim 22, wherein the threshold value in step VI is less than one tenth of the pixel dimension size.

28. A non-transitory computer program product comprising at least one computer-readable storage medium having computer-readable program code portions embodied therein, the computer-readable program portions comprising one or more executable portions configured for performing the method of claim 15.
